(19) United States
(12) Patent Application Publication
(10) Pub. No.: US 2012/0207467 A1
(43) Pub. Date: Aug. 16, 2012

(54) Path Computation Element System and Method of Routing and Wavelength Assignment in a Wavelength Switched Optical Network

(75) Inventor: Young Lee, Plano, TX (US)

(73) Assignee: FUTUREWEI TECHNOLOGIES, INC., Plano, TX (US)

(21) Appl. No.: 13/371,031

(22) Filed: Feb. 10, 2012

Related U.S. Application Data
(60) Provisional application No. 61/442,117, filed on Feb. 11, 2011.

(51) Int. Cl. H04B 17/00

(52) U.S. Cl. 398/16

(57) ABSTRACT

The disclosure includes an apparatus comprising a path computation element (PCE) that manages the processes of routing in an optical network, wherein the PCE receives a path computation request and provides a wavelength range to a network element (NE), and wherein the NE assigns a wavelength from the wavelength range. Also disclosed is an apparatus comprising a path computation client (PCC) that sends a path computation request to a path computation client (PCE) using path computation element communication protocol (PCEP), and receives a routing and wavelength assignment (RWA) reply to the path computation request using PCEP, wherein the RWA reply comprises an PCEP error message comprising a PCEP error object and an error value to indicate errors associated with the RWA request.

### CROSS-REFERENCE TO RELATED APPLICATIONS

The present application claims priority to U.S. Provisional Patent Application No. 61/442,117 filed Feb. 11, 2011 by Young Lee and entitled “Path Computation Element System Method of Routing and Wavelength Assignment in a Wavelength Switched Optical Network”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Wavelength division multiplexing (WDM) is one technology that is envisioned to increase bandwidth capability and enable bidirectional communications in optical networks. In WDM networks, multiple data signals can be transmitted simultaneously between network elements (NEs) using a single fiber. Specifically, the individual signals may be assigned different transmission wavelengths so that they do not interfere or collide with each other. The path that the signal takes through the network is referred to as the lightpath. One type of WDM network, a wavelength switched optical network (WSON), seeks to switch the optical signals with fewer optical-electrical-optical (OEO) conversions along the lightpath, e.g. at the individual NEs, than existing optical networks.

One of the challenges in implementing WDM networks is the determination of the routing and wavelength assignment (RWA) during path computation for the various signals that are being transported through the network at any given time. Unlike traditional circuit-switched and connection-oriented packet-switched networks that merely have to determine a route for the data stream across the network, WDM networks are burdened with the additional constraint of having to ensure that the same wavelength is not simultaneously used by two signals over a single fiber. This constraint is compounded by the fact that WDM networks typically use specific optical bands comprising a finite number of usable optical wavelengths. As such, the RWA continues to be one of the challenges in implementing WDM technology in optical networks.

Path computations can also be constrained due to other issues, such as excessive optical noise, along the lightpath. An optical signal that propagates along a path may be altered by various physical processes in the optical fibers and devices, which the signal encounters. When the alteration to the signal causes signal degradation, such physical processes are referred to as “optical impairments.” Optical impairments can accumulate along the path traversed by the signal and should be considered during path selection in WSONs to ensure signal propagation, e.g. from an ingress point to an egress point, with an acceptable amount of degradation.

### SUMMARY

In one embodiment, the disclosure includes an apparatus comprising a path computation element (PCE) that manages the processes of routing in an optical network, wherein the PCE receives a path computation request and provides a wavelength range to a network element (NE), and wherein the NE assigns a wavelength from the wavelength range.

In another embodiment, the disclosure includes an apparatus comprising a path computation client (PCC) that sends a path computation request to a path computation element (PCE) using path computation element communication protocol (PCEP), and receives a routing and wavelength assignment (RWA) reply to the path computation request using PCEP, wherein the RWA reply comprises an PCEP error message comprising a PCEP error object and an error value to indicate errors associated with the RWA request.

In yet another embodiment, the disclosure includes a method comprising performing wavelength allocation by a path computation element (PCE) by means of a label set containing one or more allocated labels provided by the PCE, wherein the means allows distributed label allocation, performed during signaling, to complete wavelength assignment (WA).

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a WSON system.

FIG. 2 is a protocol diagram of an embodiment of the communications between a PCE and a PCC.

FIG. 3 is a schematic diagram of an embodiment of a PCE architecture.

FIG. 4 is a schematic diagram of another embodiment of the PCE architecture.

FIG. 5 is a schematic diagram of another embodiment of the PCE architecture.

FIG. 6 is a schematic diagram of an embodiment of a WA object.

FIG. 7 is a schematic diagram of an embodiment of a wavelength restriction constraint type length value (TLV).

FIG. 8 is a schematic diagram of an embodiment of an internet protocol version four (IPv4) address sub-TLV.

FIG. 9 is a schematic diagram of an embodiment of an internet protocol version six (IPv6) address sub-TLV.

FIG. 10 is a schematic diagram of an embodiment of an Interface (IF) identifier (ID) sub-TLV.

FIG. 11 is a schematic diagram of an embodiment of a wavelength restriction field sub-TLV.

FIG. 12 is a schematic diagram of an embodiment of a no-path object TLV.

FIG. 13 is an embodiment of a no-path vector TLV.

FIG. 14 is an embodiment of a PCEP error object TLV.

FIG. 15 is a schematic diagram of an embodiment of a general-purpose computer system.

FIG. 16 is a schematic diagram of an embodiment of an NE.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for extending PCEP to accommodate RWA in WDM networks, such as the WSON. Previous versions of PCEP allowed the PCE to control WA using explicit label control (e.g. centralized WA) or allowed the NE's along the lightpath to determine WA (e.g. distributed WA). The extensions disclosed herein allow a compromise between centralized WA and distributed WA. The PCC may forward a wavelength constraint policy and wavelength range restrictions to the PCE. The wavelength constraint policy may include a selection preference, such as random, first fit ascending order, first fit descending order, etc., that may be used by the PCE and/or other NEs to select one wavelength for WA out of a plurality of allocated wavelengths. The wavelength range restrictions may include wavelengths that should not be considered by the PCE for WA. Wavelength range restrictions may indicate physical constraints of the system, system policy constraints, and/or temporary wavelength unavailability for other reasons. The PCE may forward limited label wavelength sets to the NEs along the predetermined route and allow the NEs to perform WA while being constrained by the wavelength sets. If no path meeting the constraints can be found by the PCE, the PCE may respond to the PCC with error indicators and/or no-path indicators, indicating to the PCC the reason no path was found. The PCEP extensions discussed herein are also set forth in Internet Engineering Task Force (IETF) document draft-lee-pce-wson-rwa-ext-03, which is incorporated herein by reference as if reproduced in its entirety.

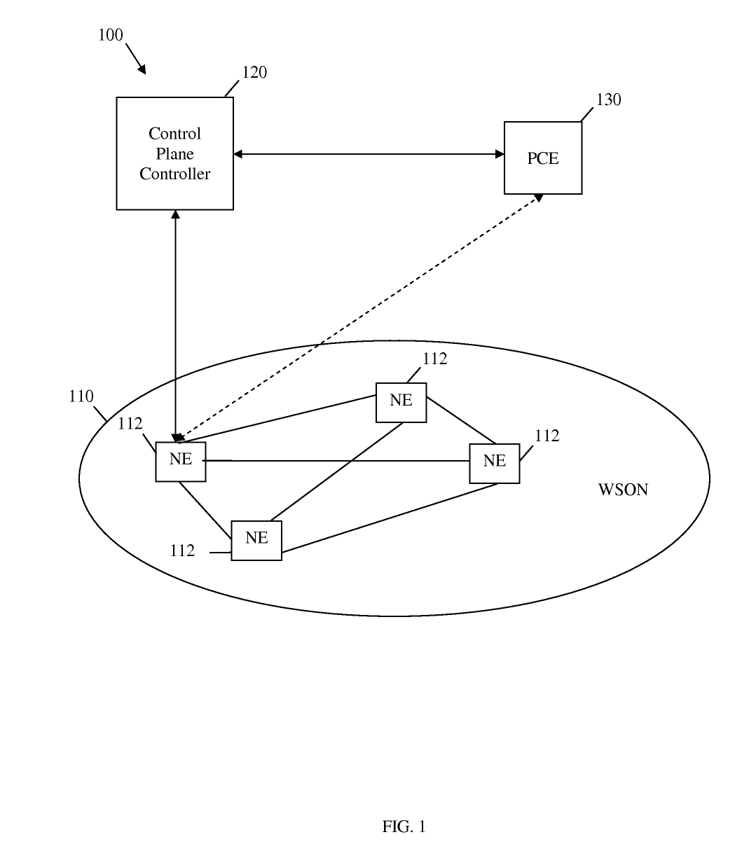

FIG. 1 illustrates one embodiment of a WSON system 100. The system 100 may comprise a WSON 110, a control plane controller 120, and a PCE 130. The WSON 110, control plane controller 120, and PCE 130 may communicate with each other via optical, electrical, or wireless means. The WSON 110 may comprise a plurality of NEs 112 coupled to one another using optical fibers. In an embodiment, the optical fibers may also be considered NEs 112. The optical signals may be transported through the WSON 110 over lightpaths that may pass through some of the NEs 112. In addition, some of the NEs 112, for example those at the ends of the WSON 110, may be configured to convert between electrical signals from external sources and the optical signals used in the WSON 110. Although four NEs 112 are shown in the WSON 110, the WSON 110 may comprise any number of NEs 112.

The WSON 110 may be any optical network that uses active or passive components to transport optical signals. The WSON 110 may implement WDM to transport the optical signals through the WSON 110, and may comprise various optical components as described in detail below. The WSON 110 may be part of a long haul network, a metropolitan network, or a residential access network.

The NEs 112 may be any devices or components that transport signals through the WSON 110. In an embodiment, the NEs 112 consist essentially of optical processing components, such as line ports, add ports, drop ports, transmitters, receivers, amplifiers, optical taps, and so forth, and do not contain any electrical processing components. Alternatively, the NEs 112 may comprise a combination of optical processing components and electrical processing components. At least some of the NEs 112 may be configured with wavelength converters, optical-electrical (OE) converters, electrical-optical (EO) converters, OEO converters, or combinations thereof. However, it may be advantageous for at least some of the NEs 112 to lack such converters as such may reduce the cost and complexity of the WSON 110. In specific embodiments, the NEs 112 may comprise optical cross connects (OXCs), photonic cross connects (PXCs), type I or type II reconfigurable optical add/drop multiplexers (ROADMs), wavelength selective switches (WSSs), fixed optical add/drop multiplexers (FOADMs), or combinations thereof.

The NEs 112 may be coupled to each other via optical fibers. The optical fibers may be used to establish optical links and transport the optical signals between the NEs 112. The optical fibers may comprise standard single mode fibers (SMFs) as defined in International Telecommunications Union Telecommunications Standardization Sector (ITU-T) standard G.652, dispersion shifted SMFs as defined in ITU-T standard G.653, cut-off shifted SMFs as defined in ITU-T standard G.654, non-zero dispersion shifted SMFs as defined in ITU-T standard G.655, wideband non-zero dispersion shifted SMFs as defined in ITU-T standard G.656, or combinations thereof. These fiber types may be differentiated by their optical impairment characteristics, such as attenuation, chromatic dispersion, polarization mode dispersion, four wave mixing, or combinations thereof. These effects may be dependent upon wavelength, channel spacing, input power level, or combinations thereof. The optical fibers may be used to transport WDM signals, such as course WDM (CWDM) signals as defined in ITU-T G.694.2 or dense WDM (DWDM) signals as defined in ITU-T G.694.1. All of the standards described herein are incorporated herein by reference.

The control plane controller 120 may coordinate activities within the WSON 110. Specifically, the control plane controller 120 may receive optical connection requests and provide lightpath signaling to the WSON 110 via an Interior Gateway Protocol (IGP) such as Generalized Multi-Protocol Label Switching (GMPLS), thereby coordinating the NEs 112 such that data signals are routed through the WSON 110 with little or no contention. In addition, the control plane controller 120 may communicate with the PCE 130 using PCEP, provide the PCE 130 with information that may be used for the RWA, receive the RWA from the PCE 130, and/or forward the RWA to the NEs 112. The control plane controller 120 may be located in a component outside of the WSON 110, such as an external server, or may be located in a component within the WSON 110, such as a NE 112.

The PCE 130 may perform all or part of the RWA for the WSON system 100. Specifically, the PCE 130 may receive the wavelength or other information that may be used for the RWA from the control plane controller 120, from the NEs 112, or both. The PCE 130 may process the information to obtain the RWA, for example, by computing the routes, e.g. lightpaths, for the optical signals, specifying the optical wavelengths that are used for each lightpath, and determining the NEs 112 along the lightpath at which the optical signal should be converted to an electrical signal or a different wavelength. The RWA may include at least one route for each incoming signal and at least one wavelength associated with each route. The PCE 130 may then send all or part of the RWA information to the control plane controller 120 or directly to the NEs 112. To assist the PCE 130 in this process, the PCE 130 may comprise a global traffic-engineering database (TED), a RWA information database, an optical performance monitor (OPM), a physical layer constraint (PLC) information database, or combinations thereof. The PCE 130 may be located in a component outside of the WSON 110, such as an external server, or may be located in a component within the WSON 110, such as a NE 112.

In some embodiments, the RWA information may be sent to the PCE 130 by a path computation client (PCC). The PCC may be any client application requesting a path computation to be performed by the PCE 130. The PCC may also be any network component that makes such a request, such as the control plane controller 120, or any NE 112, such as a ROADM or a FOADM.

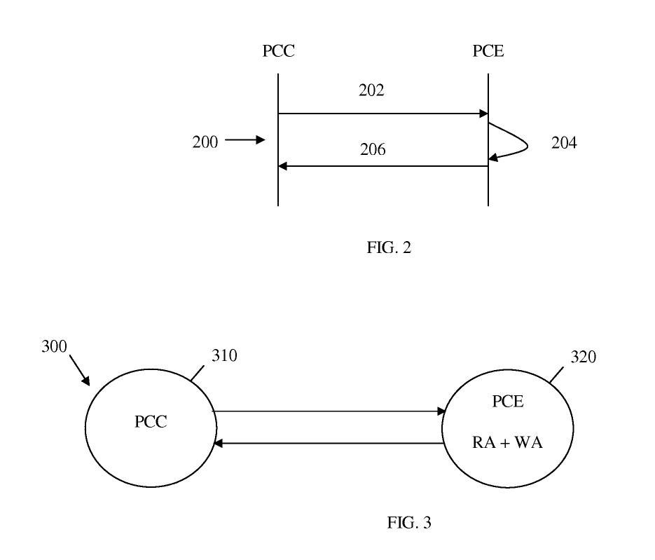

FIG. 2 illustrates an embodiment of a path computation communication method 200 between the PCC and the PCE. The method 200 may be implemented using any suitable protocol, such as the PCEP. In the method 200, the PCC may send a path computation request 202 to the PCE. The request may include any of the lightpath constraints and/or restrictions disclosed below. At 204, the PCE calculates a path through the network that meets the lightpath constraints. For example, the PCE may calculate the RWA. The PCE may then send a path computation reply 206 to the PCC. The reply 206 may comprise the RWA or one of the other reply options described below.

When a network comprises a plurality of PCEs, not all PCEs within the network may have the ability to calculate the RWA. Therefore, the network may comprise a discovery mechanism that allows the PCC to determine the PCE in which to send the request 202. For example, the discovery mechanism may comprise an advertisement from a PCC for a RWA-capable PCE, and a response from the PCEs indicating whether they are RWA-capable. The discovery mechanism may be implemented as part of the method 200 or as a separate process.

The PCE may be embodied in one of several architectures. FIG. 3 illustrates an embodiment of a combined RWA architecture 300. In the combined RWA architecture 300, the PCC 310 communicates the RWA request and the required information to the PCE 320, which implements both the routing assignment and the wavelength assignment functions using a single computation entity, such as a processor. For example, the processor may process the RWA information using a single or multiple algorithms to compute the lightpaths as well as to assign the optical wavelengths for each lightpath. The amount of RWA information needed by the PCE 320 to compute the RWA may vary depending on the algorithm used. If desired, the PCE 320 may not compute the RWA until sufficient network links are established between the NEs or when sufficient RWA information about the NEs and the network topology is provided. The combined RWA architecture 300 may be preferable for network optimization, smaller WSONs, or both.

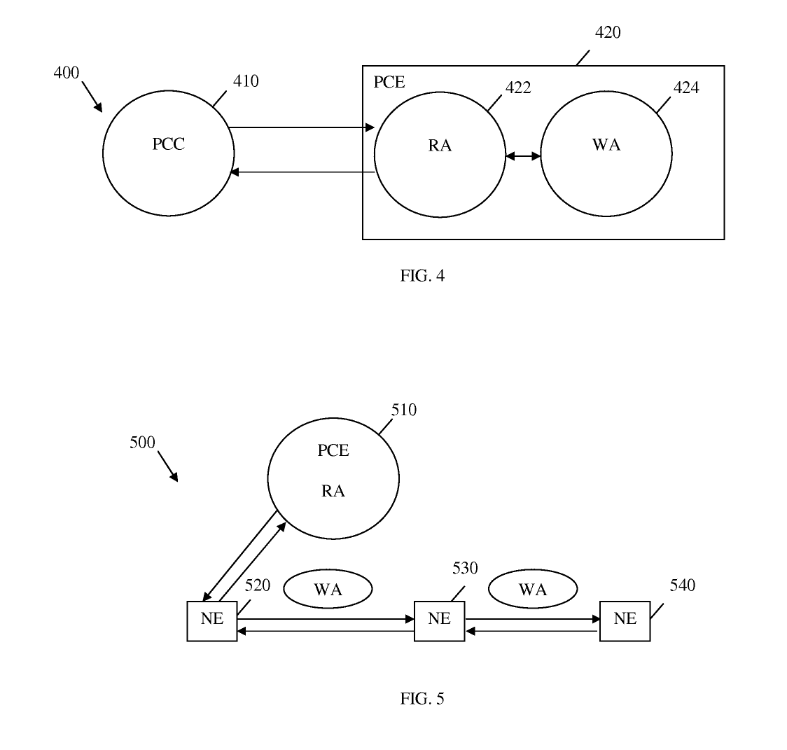

FIG. 4 illustrates an embodiment of a separated RWA architecture 400. In the separated RWA architecture 400, the PCC 410 communicates the RWA request and the required information to the PCE 420, which implements both the routing function and the wavelength assignment function using separate computation entities, such as processors 422 and 424. Alternatively, the separated RWA architecture 400 may comprise two separate PCEs 420 each comprising one of the processors 422 and 424. Implementing routing assignment and wavelength assignment separately may offload some of the computational burden on the processors 422 and 424 and reduce the processing time. In an embodiment, the PCC 410 may be aware of the presence of only one of two processors 422, 424 (or two PCEs) and may only communicate with that processor 422, 424 (or PCE). For example, the PCC 410 may send the RWA information to the processor 422, which may compute the lightpath routes and forward the routing assignment to the processor 424 where the wavelength assignments are performed. The RWA may then be passed back to the processor 422 and then to the PCC 410. Such an embodiment may also be reversed such that the PCC 410 communicates with the processor 424 instead of the processor 422.

In either architecture 300 or 400, the PCC may receive a route from the source to destination along with the wavelengths, e.g. GMPLS generalized labels, to be used along portions of the path. The GMPLS signaling supports an explicit route object (ERO). Within an ERO, an ERO label sub-object can be used to indicate the wavelength to be used at a particular NE. In cases where the local label map approach is used, the label sub-object entry in the ERO may have to be translated.

FIG. 5 illustrates an embodiment of a distributed wavelength assignment architecture 500. In the distributed wavelength assignment architecture 500, an NE acting as a PCC, in this case NE 520, may communicate with the PCE 510 using PCEP. The PCC may send a path computation request (PCReq) to the PCE 510. The path computation request may comprise a selection preference for WA, such as random assignment, first fit descending order, first fit ascending order, or similar selection preference. The path computation request may also comprise a restriction on the wavelengths that may be used in WA. The wavelength selection preference and the wavelength restrictions may be communicated using a WA object and/or a wavelength restriction TLV as discussed below.

The PCE 510 may receive some or all of the RWA information from the NEs 520, 530, and 540, perhaps via direct link, and may implement the routing assignment. Specifically, the NE 520 may receive local RWA information from the NEs 530 and 540 and (acting as a PCC) send some or all of the RWA information to the PCE 510. The PCE 510 may compute the lightpaths using the RWA information received from NE 520. The PCE 510 may use distributed label allocation to complete the WA by generating a label set of available wavelengths, which may be all available wavelengths for the route less those excluded by the restrictions provided by the PCC. The PCE 510 may then directly or indirectly pass the routing assignment and the label set to the individual NEs 520, 530, and 540 (e.g. in the form of a path computation reply (PCRep) message). The NE 520 may use the list of lightpaths to identify the NE 530 as the next NE in the lightpath. The NE 520 may use the label set received from the PCE 510 and local RWA information that may comprise additional constraints to assign a wavelength for transmission over the link to NE 530. NE 520 may then send the list of lightpaths, the WA, and the label set of wavelengths to NE 530. NE 530 may use the list of lightpaths to identify the NE 540 as the next NE in the lightpath and assign the same or a different wavelength for transmission over the link to NE 540 while being constrained by the label set and local RWA information. NE 530 may prefer to assign the same wavelength between NE 530 and NE 540 as was used between NE 520 and NE 530, as using the same wavelength alleviates the need to use system resources to perform a wavelength conversion. Thus, the signals may be routed and the wavelengths may be assigned in a distributed manner between the remaining NEs in the network, while being constrained to the label set provided by the PCE 510. Assigning the wavelengths at the individual NEs based on a label set created by the PCE 510 may reduce the amount of RWA information that has to be sent to the PCE 510, while allowing the PCE 510 and the PCC to maintain a level of control over WA. NE 540 may send a message to the PCE 510 with the results of the WA request by way of NE 530 and NE 520.

A PCReq message, sent from a PCC to a PCE 510, may comprise a WA object as discussed below and may be encoded with several other objects. A PCReq may be encoded with a common header, a Synchronization Vector (SVEC) list, and a request list. The request list may comprise a request object and a request list object. The request object may comprise a request parameters (RP) object which may be as defined in IETF document request for comment (RFC) 5440, which is incorporated herein by reference. The request object may further comprise an endpoints object, a WA object, and other optional objects as needed. The WA object may be encoded after the endpoints object in the PCReq.

A PCRep message, sent from the PCE 510 to the PCC, may comprise an ERO. The ERO may be used to encode the path of a traffic engineering (TE) label switched path (LSP) through the network. The ERO may be carried within a given path of a PCEP response (e.g. returned to the PCE 510 by the NEs 520, 530, and 540) and in turn carried in the PCRep message to provide the computed TE LSP if the path computation was successful. The allocated wavelength may be conveyed by means of explicit label control (ELC). In order to encode WA, the WA object, discussed below, may be employed to specify the assignment. The WA object may be aligned with the ERO object because each segment of the computed optical path may be associated with a WA.

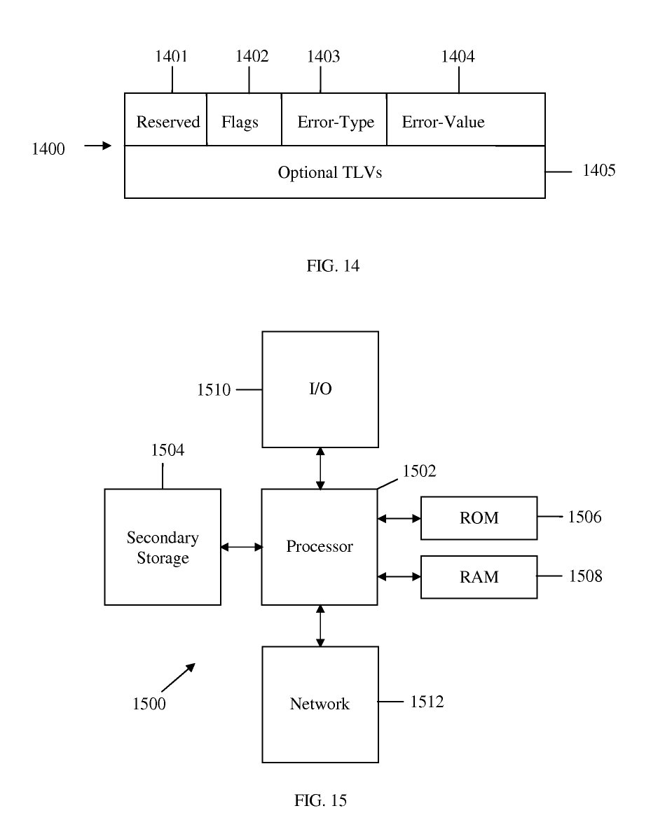

When the PCE 510 determines that an error has occurred or that no RWA satisfies the requirements/constraints, the PCRep message may indicate such. To indicate errors associated with RWA request (e.g. the PCReq), a PCE Error (PCErr) message may be sent from the PCE 510 to the PCC. The PCErr message may comprise an error object comprising an error type and error values to indicate which errors occurred when processing the RWA request. For example, the PCErr message may comprise an error object with an error value of one to indicate that the PCE 510 received the RWA request, but was unable to process the request due to insufficient memory. The PCE error object is discussed more fully below in reference to FIG. 14. The PCE 510 may stop processing the request and the corresponding RWA request may be cancelled at the PCC. The PCErr message may comprise an error value of two and an error type of fifteen to indicate that the PCE 510 received the RWA request, but is not capable of performing RWA computation. The PCE 510 may stop processing the request and the corresponding RWA request may be cancelled at the PCC. When no RWA meets all requirements and constraints, the PCE 510 may include a no-path object in the PCRep message to communicate the reason(s) for not being able to find RWA for the request. The format of the no-path object body may be defined in IETF document RFC 5440. The no-path object may comprise a no-path vector TLV that comprises information about why a path computation has failed. Two new bit flags are defined herein that may be carried in the flags field in the No-path vector TLV carried in the no-path object. The flags, when set, inform the PCC that the PCE 510 indicates that no feasible route was found that meets the constraints associated with the RWA, that no wavelength was assigned to at least one hop of the route in the response, or that no path was found satisfying the signal compatibility constraints.

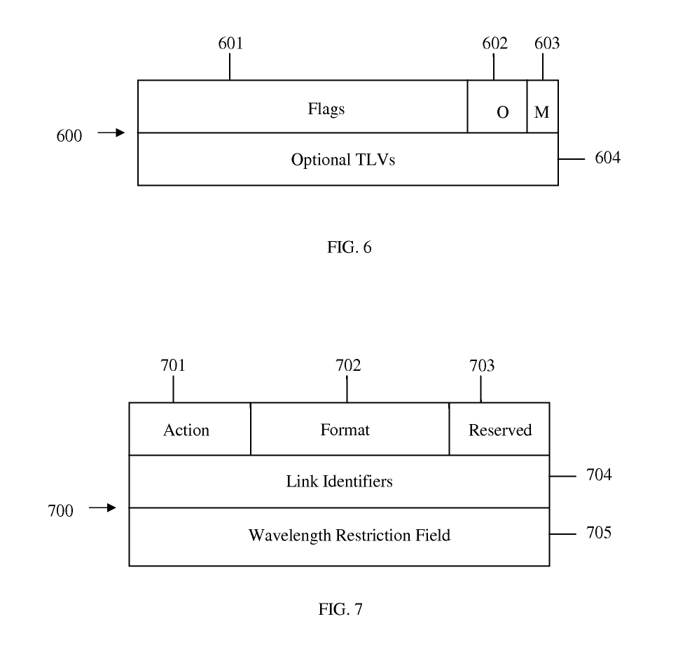

FIG. 6 illustrates an embodiment of a WA object 600. The WA object 600 may comprise a flags field 601, which may be thirty two bits in length (e.g. bits 00-31), may extend from the zero bit position to the thirty first bit position, and may comprise a mode bit 603 and three order bits 602. The mode bit 603 may be used to indicate the mode of wavelength assignment. The mode bit 603 may be one bit in length and may be located at the thirty first bit position of the flags field 601. The mode bit 603 may be set to one to indicate that labels must be assigned by the PCE for each hop of a computed lightpath using explicit label control as defined by IETF document RFC 4003, which is incorporated herein by reference (i.e. centralized wavelength assignment). The mode bit 603 may be set to zero to indicate that labels may be assigned by the NEs in a non-explicit, distributed fashion (e.g. with or without being constrained by label sets of preferred wavelengths provided by other components). If the mode bit 603 is set to zero, the PCE may be required to return a routing assignment and a wavelength range using a label set if RWA is found. The order bits 602 may be three bits in length and may be included as the twenty eighth bit through the thirtieth bit of the flags field 601. The order bits 602 may be used to indicate a WA constraint in regard to the order of WA to be returned by the PCE. For example, the order bits 602 may be used to indicate that the WA should be completed using random assignment, first fit (FF) in descending order, FF in ascending order, last fit (LF) in ascending order, LF in descending order, or a vendor specific/private selection preference. The encoding of the order bits 602 may be as follows: 000 for Reserved; 001 for Random Assignment; 010 for FF in descending order; 011 for FF in ascending order; 100 for LF in ascending order; 101 LF in descending order; 110 for Vendor Specific/Private; and 111 for Reserved. In some embodiments, the wavelength selection preference encoded in the order bits 602 may only be used if the PCE assigns all wavelengths in a centralized fashion (e.g. if the mode bit is set to 1). The WA object 600 may also include one or more optional TLVs 604, which may include information such as a wavelength range and/or a maximum number of wavelengths to be returned in the label set in response to the RWA computation. The optional TLVs 604 may comprise additional thirty two bit sections as needed.

A wavelength restriction constraint TLV as discussed below may be sent from a PCC to a PCE as part of a PCReq requesting WA. A wavelength restriction TLV allows the requesting PCC to specify a restriction on the wavelengths to be used. A PCE may interpret the wavelength restrictions received from the PCC as constraints on the tuning ability of the originating laser transmitter, policy constraints, or any other maintenance related constraints. For example, the PCC may reserve certain wavelengths as a matter of general policy (e.g. so that they are only used in emergencies) or because of a particular issue known to the PCC. If the LSP spans different segments, the PCE may require mechanisms to know the tuneability restrictions of any involved wavelength converters/regenerators (e.g. by means of a traffic engineering database (TED), either via interior gateway protocol (IGP) or a network management system (NMS)). Even if the PCE is aware of the tuneability of the transmitter, the PCC may apply additional constraints to the PCReq. The wavelength restriction constraint TLV may be part of the WA object 600, an endpoints object, or any other object associated with path computation requests. Tunability restrictions may be applied to the link layer of the Internet Protocol Suite.

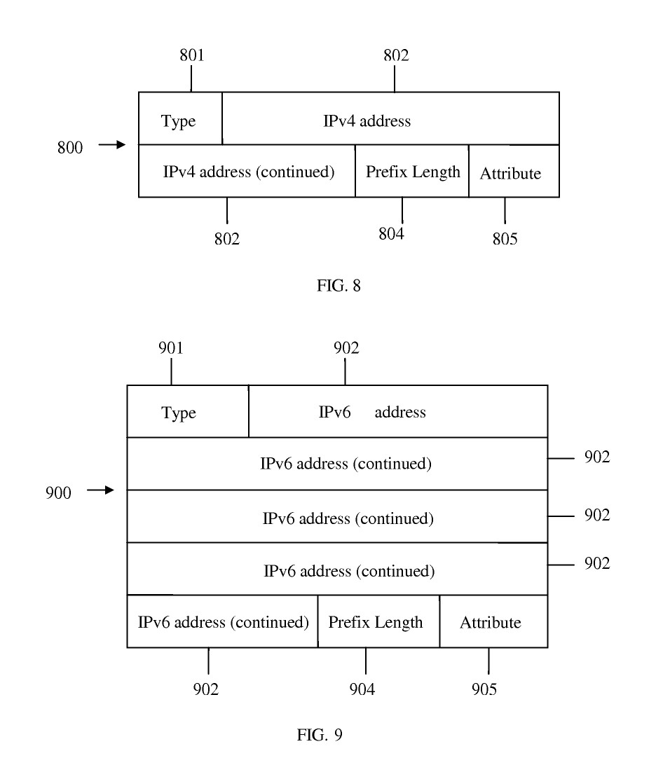

FIG. 7 illustrates an embodiment of a wavelength restriction constraint TLV 700. The wavelength restriction constraint TLV 700 may comprise an action field 701, a format field 702, a reserved field 703, a link identifiers field 704, and a wavelength restriction field 705. The wavelength restriction constraint TLV 700 may comprise a first thirty two bit section (e.g. bits 00-31) containing the action field 701, format field 702, and reserved field 703, additional thirty two bit sections to contain each link identifiers field 704, as necessary, and additional thirty two bit sections to contain each wavelength restriction field 705, as necessary. The action field 701 may be nine bits long, may extend from the zero bit position to the eighth bit position, and may indicate whether the information in the link identifiers field 704 should be interpreted as a range of links or as individual links. The action field 701 may be encoded using a zero in a bit location to indicate that a corresponding link identifier is an inclusive list of one or more link identifiers included in a link set. Each identified link is a separate link that is part of the set. A one in a bit location in the action field 701 may be used to indicate that a corresponding link identifier is an inclusive range of links expressed as a link set. An inclusive range may contain two link identifiers indicating the start and end of the range (inclusive). All links with numeric values between the two link identifiers may be considered part of the link set. A value of zero may be placed in either the start or end link identifier position and may indicate that there is no boundary to the start of the range or no boundary to the end of the range, respectively. The action field 701 may also be encoded with a zero when an unnumbered link identifier is employed. The format field 702 may be eight bits long, may extend from the ninth bit position to the sixteenth bit position, and may indicate the format of the link(s) identified in the link identifiers field 704. The format field 702 may indicate that the link(s) in the link identifiers field 704 are unnumbered links, local interface IPv4 addresses, or local interface IPv6 addresses. The encoding of the format field 702 may be as follows: zero for Unnumbered Interface ID; one for Local Interface IPv4 Address; two for Local Interface IPv6 Address; and other values reserved for future updates. The reserved field 703 may be sixteen bits long, may extend from the seventeenth bit position to the thirty-first bit position, and may be reserved for future updates. The link identifiers field 704 may identify the link or links associated with the restriction and may comprise one or more sub-TLVs of the types indicated by the format field 702. The link identifier field 704 may comprise an IPv4 sub-TLV, an IPv6 sub-TLV, or an unnumbered IF ID sub-TLV. Example embodiments of link identifier sub-TLVs are shown in FIGS. 8-10 and discussed below. The wavelength restriction field 705 may be encoded as a label set field sub-TLV, as specified in IETF document draft-ietf-ccamp-general-constraint-encode-06, which is incorporated by reference, with base label encoded as a thirty two bit lambda-switch-capable (LSC) label as described in IETF document RFC 6205, which is incorporated by reference. An example embodiment of a wavelength restriction field 705 sub-TLV is shown in FIG. 11 and discussed below.

FIG. 8 illustrates an embodiment of an IPv4 address sub-TLV 800. The sub-TLV 800 is an embodiment of a link identifier sub-TLV that may be included in the link identifier field 704 of the wavelength restriction constraint TLV 700. The sub-TLV 800 may comprise a type field 801, an IPv4 address field 802, a prefix length field 804, and an attribute field 805, and may comprise two thirty two bit sections. The type field 801 may be nine bits long, may extend from the zeroth to the eighth bit positions in the first thirty two bit section, and may indicate that the sub-TLV is an IPv4 address sub-TLV 800 by using an encoding of the number 1. The IPv4 address field 802 may be thirty nine bits long, may extend from the ninth bit position in the first thirty two bit section to the fifteenth bit position in the second thirty two bit section, and may identify a link in IPv4 address format. The prefix length field 804 and the attribute field 805 may each be eight bits long, may be located in the second thirty two bit section, and may indicate the length of the address prefix and any attributes associated with the link, respectively. The prefix length field 804 may extend from the sixteenth bit position to the twenty third bit position. The attribute field 805 may extend from twenty fourth bit position to the thirty first bit position.

FIG. 9 illustrates an embodiment of an IPv6 address sub-TLV 900. The sub-TLV 900 is an embodiment of a link identifier sub-TLV that may be included in the link identifiers field 704 of the wavelength restriction constraint TLV 700. The sub-TLV 900 may comprise a type field 901, an IPv6 address field 902, a prefix length field 904 and an attribute field 905, and may comprise five thirty two bit sections. The type field 901 may be nine bits long, may extend from the zeroth to the eighth bit positions of the first thirty two bit section, and may indicate that the sub-TLV is an IPv6 address sub-TLV 900 by using an encoding of the number 2. The IPv6 address field 902 may be one hundred thirty five bits long and may identify a link in IPv6 address format. The IPv6 address field 902 may extend from the ninth bit position of the first thirty two bit section to the fifteenth bit position of the fifth thirty two bit section. The prefix length field 904 and the attribute field 905 may each be positioned and encoded in substantially the same manner as 804 and 805, except they may be positioned in the fifth thirty two bit section.

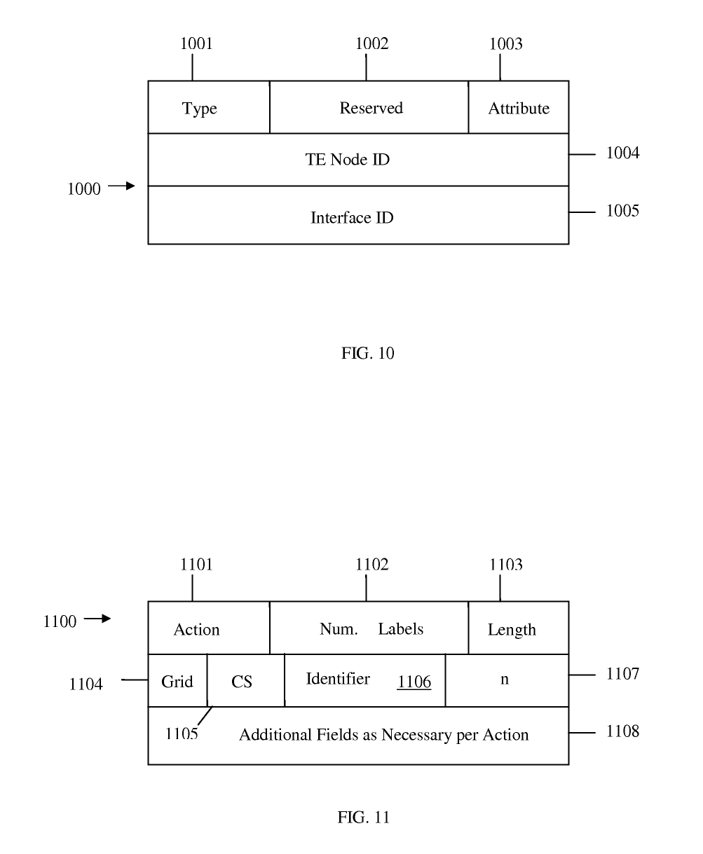

FIG. 10 illustrates an embodiment of an unnumbered IF ID sub-TLV 1000. The sub-TLV 1000 is an embodiment of a link identifier sub-TLV that may be included in the link identifiers field 704 of the wavelength restriction constraint TLV 700. The sub-TLV 1000 may comprise a type field 1001, a reserved field 1002, an attribute field 1003, a TE Node ID field 1004 and an interface ID field 1005 and may comprise three thirty two bit sections. The type field may be nine bits long, may extend from the zeroth bit position to the eighth bit position, and may indicate that the sub-TLV is an unnumbered interface ID sub-TLV 1000 by using an encoding of the number 4. The reserved field 1002 may be eight bits long, may extend from the ninth bit position to the sixteenth bit position, and may be reserved for future updates. The attribute field 1003 may be fifteen bits long, may extend from the seventeenth bit position to the thirty first bit position, and may indicate any attributes associated with the link. The type field 1001, reserved field 1002, and attribute field 1003 may be positioned in the first thirty two bit section. The TE Node ID field 1004 and interface ID field 1005 may each be thirty two bits long and may identify a link by the node and port to which the link is connected. The link may be unidirectional or bidirectional. The TE Node ID field 1004 may extend from the zeroth bit position to the thirty first bit position of the second thirty two bit section. The interface ID field 1005 may extend from the zeroth bit position to the thirty first bit position of the third thirty two bit section.

FIG. 11 illustrates an embodiment of a wavelength restriction field sub-TLV 1100. The sub-TLV 1100 is an embodiment of a sub-TLV that may be included in the wavelength restriction field 705 of the wavelength restriction constraint TLV 700. The sub-TLV 1100 may comprise an action field 1101, a number labels field 1102, a length field 1103, a grid field 1104, a channel spacing field 1105, an identifier field 1106, a two's-complement integer (N) field 1107, and additional fields 1108. The sub-TLV may comprise two or more thirty two bit sections. Fields 1101, 1102, and 1103 may be positioned in the first thirty two bit sections and encoded as discussed in IETF document draft-ietf-ccamp-general-constraint-encode-06. Fields 1104, 1105, 1106, and 1107 may be positioned in the second thirty two bit sections and encode lambda labels as discussed in IETF document RFC 6205, which is incorporated by reference. The action field 1101 may be four bits in length, may extend from the zeroth bit position to the third bit position, and may indicate whether the enclosed information is an inclusive list, an exclusive list, an inclusive range, an exclusive range, or a bitmap set using the values zero through four, respectively. The number labels field 1102 may be twelve bits long, may extend from the fourth bit position to the fifteenth bit position, and may indicate the number of labels included in a bitmap set. In a bitmap set, each bit in the bit map may represent a particular lambda label with a value of one or zero indicating whether the label is in the set or not. Bit position zero may represent the lowest label and may correspond to the base label, while each succeeding bit position may represent the next label logically above the previous. The length field 1103 may be sixteen bits long, may extend from the sixteenth bit position to the thirty first bit position, and may indicate the length in bytes of the entire sub-TLV 1100. The grid field 1104, channel spacing (CS) field 1105, identifier field 1106, and N field 1107, may have lengths of three bits, four bits, nine bits, and sixteen bits and may extend from the zeroth bit position to the second bit position, third bit position to the sixth bit position, seventh bit position to the fifteenth bit position, and sixteenth bit position to the thirty first bit position, respectively. Fields 1104, 1105, 1106, and 1107 may indicate information regarding a restricted label in lambda label format. This information may include the type of optical system associated with the label, channel spacing on the link, an identifier for the link, and information used to calculate signal frequency over the link, respectively, as encoded in IETF document RFC 6205. Additional fields 1108 may be included in additional thirty two bit sections as needed per action. The additional fields 1108 may include additional restricted labels using fields substantially similar to fields 1104-1107.

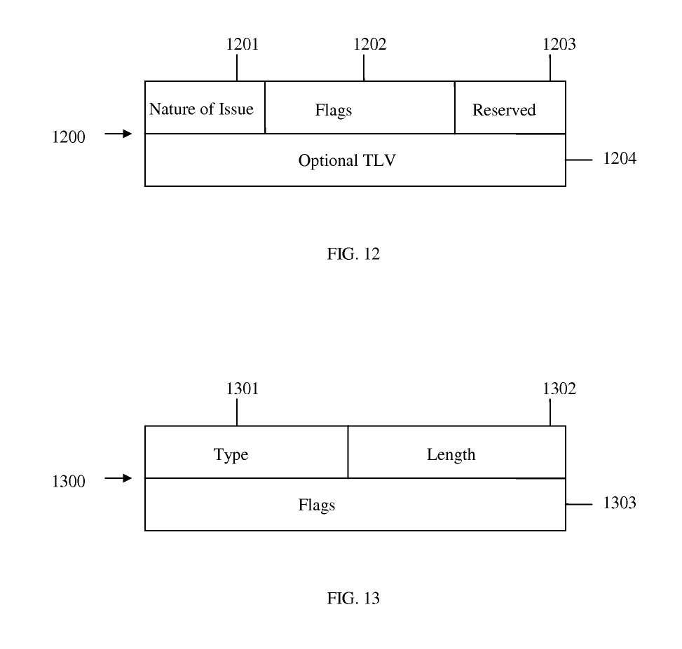

FIG. 12 illustrates an embodiment of a no-path object 1200. The no-path object 1200 may be included in a PCRep message sent by a PCE to a PCC in response to a PCReq message when the PCE is unable to find an RWA that meets the PCCs constraints as discussed above in relation to FIG. 5. Encodings for the no-path object 1200 are discussed in IETF document RFC 5440. The no-path object 1200 may comprise a nature of issue field 1201, a flags field 1202, a reserved field 1203, and an optional TLV field 1204. The nature of issue field 1201 may be eight bits long, may extend from the zeroth bit to the seventh bit, and may indicate the reasons no RWA was found for a path computation request. Reasons for no RWA may include, no path satisfying a set of constraints was found or the PCE chain was broken. The flags field 1202 may be sixteen bits long, may extend from the eight bit to the twenty third bit, and may indicate the set of unsatisfied constraints. The reserved field 1203 may be eight bits long, may extend from the twenty fourth bit to the thirty first bit, and may be reserved for future updates. Additional TLVs may be added to the optional TLV field 1204 as needed for a given application.

FIG. 13 illustrates an embodiment of a no-path-vector TLV 1300. A no-path-vector TLV 1300 may be included as an optional TLV 1204 in a no-path object 1200, and may provide additional information as to why no RWA was found. A no-path-vector TLV may comprise a type field 1301, a length field 1302, and a flags field 1303. The type field 1301 may be sixteen bits long, may extend from the zeroth bit to the fifteenth bit, and may be used to indicate that the TLV is a no-path-vector TLV 1300 using a value of one. The length field 1302 may be sixteen bits long, may extend from the sixteenth bit to the thirty first bit, and may be used to indicate the length of the TLV. The flags field 1303 may be thirty two bits long and may indicate a reason no RWA was found. Such reasons may include: no feasible route was found that meets all constraints of RWA, no wavelength was assigned to at least one hop of the route, no path was found satisfying signal compatibility constraints, PCE is currently unavailable, unknown route destination, or unknown route source.

FIG. 14 is an embodiment of a PCEP error object 1400 TLV. A PCEP error object 1400 may be included as part of a PCErr message as discussed above. The PCEP error object 1400 may report a PCEP error and is encoded as defined in IETF document RFC 5440. The PCEP error object may also report the reason for the error. The PCEP error object may comprise a reserved field 1401, a flags field 1402, an error-type field 1403, an error-value field 1404, and an optional TLVs field 1405. The reserved field 1401 may be eight bits long, may extend from the zeroth bit to the seventh bit, and may be reserved for future updates. The flags field 1402 may be eight bits long, may extend from the eighth bit to the fifteenth bit, and may be used to encode flags related to errors. The error-type field 1403 may be eight bits long, may extend from the sixteenth bit to the twenty third bit, and may be used to encode the general class of error that occurred when a PCE received a routing and/or WA request. The error-value field 1404 may be eight bits long, may extend from the twenty fourth bit to the thirty first bit, and may be used to encode an error value that indicates the reasons for the error. For example, the error value field may be set to one if the PCE is unable to process a request due to insufficient memory. The error value field may be set to two if the PCE is unable to process a request because the PCE is not capable of RWA computation.

The network components and methods described above may be implemented on any general-purpose network component, such as a computer or network component with sufficient processing power, memory resources, and network throughput capability to handle the necessary workload placed upon it. FIG. 15 illustrates a typical, general-purpose network component 1500 suitable for implementing one or more embodiments of the components and methods disclosed herein. The network component 1500 includes a processor 1502 (which may be referred to as a central processor unit or CPU) that is in communication with memory devices including secondary storage 1504, read only memory (ROM) 1506, random access memory (RAM) 1508, input/output (I/O) devices 1510, and network connectivity devices 1512. The processor may be implemented as one or more CPU chips, or may be part of one or more application specific integrated circuits (ASICs), and/or digital signal processors (DSPs).

The secondary storage 1504 is typically comprised of one or more disk drives or tape drives and is used for non-volatile storage of data and as an over-flow data storage device if RAM 1508 is not large enough to hold all working data. Secondary storage 1504 may be used to store programs that are loaded into RAM 1508 when such programs are selected for execution. The ROM 1506 is used to store instructions and perhaps data that are read during program execution. ROM 1506 is a non-volatile memory device that typically has a small memory capacity relative to the larger memory capacity of secondary storage. The RAM 1508 is used to store volatile data and perhaps to store instructions. Access to both ROM 1506 and RAM 1508 is typically faster than to secondary storage 1504.

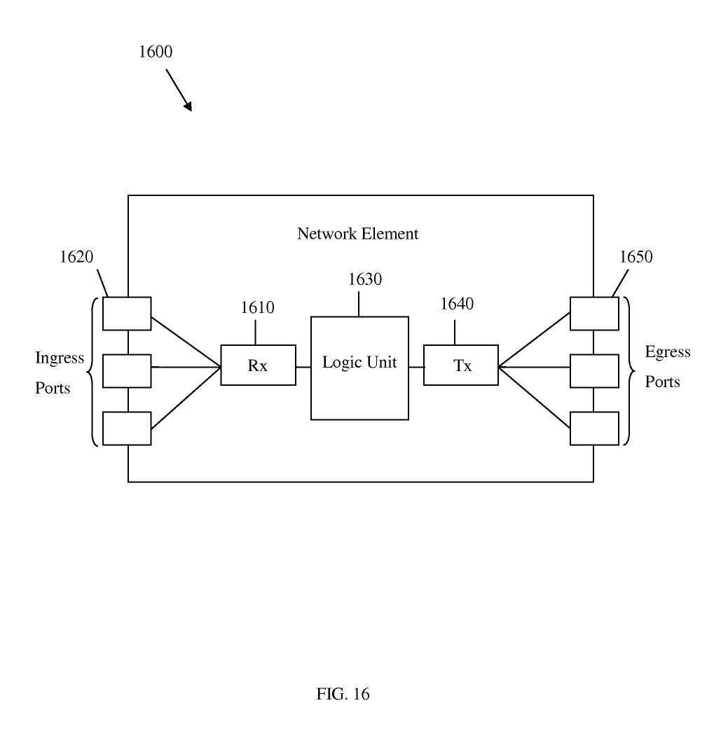

FIG. 16 is a schematic diagram of an embodiment of an NE 1600, which may function as a node in network 100, 300, 400 and/or 500. NE 1600 may function as a PCE, PCC, and/or any of the NE's disclosed herein. One skilled in the art will recognize that the term NE encompasses a broad range of devices of which NE 1600 is merely an example. NE 1600 is included for purposes of clarity of discussion, but is in no way meant to limit the application of the present disclosure to a particular NE embodiment or class of NE embodiments. At least some of the features/methods described in the disclosure may be implemented in a network apparatus or component, such as an NE 1600. For instance, the features/methods in the disclosure may be implemented using hardware, firmware, and/or software installed to run on hardware. The NE 1600 may be any device that transports frames through a network, e.g., a switch, router, bridge, server, etc. As shown in FIG. 16, the NE 1600 may comprise a receiver (Rx) 1610 coupled to plurality of ingress ports 1620 for receiving frames from other nodes, a logic unit 1630 coupled to the receiver to determine which nodes to send the frames to, and a transmitter (Tx) 1640 coupled to the logic unit 1630 and to plurality of egress ports 1650 for transmitting frames to the other nodes. The logic unit 1630 may comprise one or more multi-core processors and/or memory devices, which may function as data stores. The ingress ports 1620 and/or egress ports 1650 may contain electrical and/or optical transmitting and/or receiving components. NE 1600 may or may not be a routing component that makes routing decisions.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

I claim:

1. An apparatus comprising:
a path computation element (PCE) that computes routes for a lightpath in an optical network and comprises a receiver that receives a path computation request; a logic unit that calculates a plurality of possible wavelengths that can be used along a lightpath; and a transmitter that transmits the plurality of possible wavelengths to a network element (NE) along the lightpath,
wherein the NE assigns a wavelength to the lightpath from the plurality of possible wavelengths.

2. The apparatus of claim 1, wherein the plurality of possible wavelengths comprises a label set.

3. The apparatus of claim 1, wherein the path computation request specifies a restriction on the wavelengths to be used in the plurality of possible wavelengths.

4. The apparatus of claim 3, wherein the restriction on the wavelengths to be used in the plurality of possible wavelengths is encoded in a wavelength restriction constraint type length value (TLV) that comprises one or more of: a link identifiers field that comprises a link identifier (ID) for a link; a format field that indicates the format of the link; an action field that indicates if the link is part of an inclusive list or an inclusive range; and a wavelength restriction field that comprises a restricted label associated with the link.

5. The apparatus of claim 4, wherein the wavelength restriction field further comprises one or more of:
a wavelength restriction field sub-TLV that comprises one or more labels encoded in a grid field; a channel spacing field; an identifier field; and a two's-complement integer (N) field;
wherein the wavelength restriction field sub-TLV further comprises one or more of an action field, a number labels field, and a length field;
wherein the action field indicates whether the labels are represented as one or more of an exclusive range, inclusive range, exclusive list, inclusive list, and a bitmap set;
wherein the number labels field indicates the labels included in a bitmap set; and
wherein the length field encodes the length of the wavelength restriction field sub-TLV.

6. The apparatus of claim 4, wherein the link identifiers field comprises a sub-TLV that comprises the link ID for the link, and wherein the link identifiers field is selected from the group consisting of an internet protocol version four (IPv4) address sub-TLV, an internet protocol version six (IPv6) address sub-TLV, and an unnumbered link identifier sub-TLV.

7. The apparatus of claim 1, wherein the path computation request comprises a wavelength assignment (WA) object TLV, and wherein the WA object TLV comprises a flags field that comprises one or more order bits that encode a wavelength selection preference and a mode bit that indicates whether the path computation should be performed using explicit label control or non-explicit label control.

8. The apparatus of claim 1, wherein the path computation request message is transmitted using path computation element communication protocol (PCEP).

9. An apparatus comprising:
a path computation client (PCC) comprising a transmitter that sends a path computation request to a path computation element (PCE) using path computation element communication protocol (PCEP); and a receiver that receives a reply to the path computation request using PCEP;
wherein the path computation request comprises a request for routing and wavelength assignment (RWA) by distributed label allocation, and
wherein the reply indicates that an error occurred, that no path satisfying the constraints was found, or both.

10. The apparatus of claim 9, wherein the reply comprises a PCEP error message comprising a PCEP error object to indicate errors associated with the RWA request.

11. The apparatus of claim 10, wherein the PCEP error message is sent if the PCE is not capable of processing the request due to insufficient memory or is not capable of performing the RWA computation.

12. The apparatus of claim 11, wherein the PCEP error object comprises an error type field that encodes the class of error and an error value field that encodes the reason for the error.

13. The apparatus of claim 9, wherein the reply comprises a no-path object that carries a no-path-vector type length value (TLV) that comprises information that: no feasible route was found that meets the constraints associated with RWA; no wavelength was assigned to at least one hop of the route; or no path was found satisfying signal compatibility constraints.

14. The apparatus of claim 13, wherein the no-path-object comprises a nature of issue field that encodes a reason no path could be computed, and a flags field that encodes a set of unsatisfied constraints related to the path computation.

15. The apparatus of claim 13, wherein the no-path-vector TLV comprises one or more of a type field that indicates the no-path-vector TLV is a no-path-vector TLV; a length field that indicates the length of the no-path-vector TLV; and a flags field that encodes the information that no feasible route was found that meets the constraints associated with RWA, no wavelength was assigned to at least one hop of the route, or no path was found satisfying signal compatibility constraints.

16. A method comprising:
providing, by a path computation element (PCE), a label set containing one or more allocated labels; and
performing, during signaling, distributed label allocation to complete wavelength assignment (WA).

17. The method of claim 16, further comprising receiving a request that contains a WA from a path communication client (PCC), wherein the PCC specifies a restriction on the wavelengths to be used.

18. The method of claim 17, wherein the wavelength restriction comprises type length value (TLV) data comprising one or more of an action field; a format field; a link identifiers field; and a wavelength restriction field.

19. The method of claim 18, wherein the link identifiers field is an unnumbered interface (IF) identifier (ID) field, an internet protocol version four (IPv4) address field, or an internet protocol version six (IPv6) address field.

20. The method of claim 17, wherein the request message incorporates a WA object, wherein the WA object comprises order bits, and wherein the order bits are used to indicate the wavelength assignment constraint in regard to the order of wavelength assignment to be returned by the PCE.

21. The method of claim 17, wherein the request involves both routing and wavelength assignment (RWA).

22. The method of claim 21, further comprising indicating errors associated with the RWA request by including a path computation element communication protocol (PCEP) error object with error values in a WA path reply, and wherein the error values indicate that the PCE is not capable of processing the request due to insufficient memory, the PCE is not capable of WA computation, or both.

23. The method of claim 21, further comprising communicating a reason for not being able to find RWA for the request by using a no-path object in a PCE reply (PCRep) message,
wherein the no-path object contains a no-path-vector TLV to provide additional information about why a path computation failed, and
wherein the no-path-vector type length value (TLV) indicates no feasible route was found that meets all the constraints associated with RWA or that no wavelength was assigned to at least one hop of the route.
